(19) United States
(12) Patent Application Publication
(10) Pub. No.: US 2003/0082020 A1
(43) Pub. Date: May 1, 2003

(54) Welded micro-drill

(76) Inventors: Fan-Hsien Lin, Taipei Hsien (TW); Chao-Feng Tsai, Taipei Hsien (TW); Chi-Feng Chen, Taipei Hsien (TW)

Correspondence Address: Alan D. Kamrath, Rider, Bennett, Egan & Arundel, LLP, 333 South Seventh Street, Suite 2000, Minneapolis, MN, 55402, US

(21) Appl. No.: 10/000,054

(22) Filed: Nov. 1, 2001

(51) Int. Cl. B23B 51/02

(52) U.S. Cl. 408/144; 408/230

(57) ABSTRACT

A micro-drill has shank made of a stainless steel. A bit is integrated with the shank by welding and made of a tungsten carbide. A tapering portion is formed behind the bit. A welded segment is located between the shank and the bit. The micro-drill has a reinforced strength, and a minimum diameter of the bit can reach 0.1 mm.

### BACKGROUND OF THE INVENTION

1. Field of the Invention

The present invention is related to a drill for a printed circuit board, and more particularly to a micro-drill which is made by welding.

2. Description of Related Art

Micro-drills for manufacturing PCBs are made of a tungsten carbide. The cost of the tungsten carbide is high, so that a conventional micro-drill is made of two different materials, i.e., a high cost and a lower cost.

Referring to FIGS. 9-11, the conventional micro-drill has a shank (60) made of a stainless steel. A bore (62) is defined in a front end thereof. A tungsten carbide rod (80) is secured in the bore (62) and a bit (82) with a thread is formed by machining on the tungsten carbide rod (80).

In the process of manufacturing the drill, the shank (60) is first heated by a pair of heating devices (70) at the front end. Therefore, the bore (62) is expanded under the high temperature and the tungsten carbide rod (80) can be inserted in the bore (62). After the shank (60) cools down and the bore (62) accordingly contracts, the tungsten carbide rod (80) is securely mounted in the bore (62). Thereafter, the bit (82) and the thread are formed on the tungsten carbide rod (80).

However, the conventional micro-drill made by this processing has the following shortcomings:

1. Because of the precision of lathes used in the manufacture of the drill, a machining precision of the bore (62) can not reach the micron-class. At the same time, because of difficulty in machining the bore (62) which is of a long-hole type, the roundness, cylindricity and diameter of the bore (62) cannot have the required micron-class precision. There are uneven forces on an interface between the bore (62) and the tungsten carbide rod (80), so that the bit (82) will have harmful oscillation at a high speed of 100,000 rpm.

2. The bore (62) is limited to a minimum diameter of 1.65 mm. If the diameter of the bore (62) is smaller than that value, the tungsten carbide rod (80) can not be secured in the bore (62).

3. Because the shank (60) and the tungsten carbide rod (80) are assembled together by an interference fit between them, an average value of the tensile resistance of the micro-drill is only 260 kg during test.

Therefore, the invention provides a welded micro-drill for machining a PCB to mitigate and/or obviate the aforementioned problems.

### SUMMARY OF THE INVENTION

The main objective of the invention is to provide a micro-drill which has a reinforced strength.

Another objective of the invention is to provide a micro-drill of which a diameter of a bit can have a minimum diameter of 0.1 mm.

A further objective of the invention is to provide a micro-drill which has a high machining precision.

Other objects, advantages and novel features of the invention will become more apparent from the following detailed description when taken in conjunction with the accompanying drawings.

### BRIEF DESCRIPTION OF THE DRAWINGS

FIG. 1 is a schematic view showing a stainless steel rod and a tungsten carbide rod which are used for manufacturing a micro-drill in accordance with the invention;

FIG. 2 is a schematic view showing that the stainless steel rod and tungsten carbide rod are welded together;

FIG. 3 is a schematic view of a first embodiment of the micro-drill of the invention shaped from the integrated stainless steel rod and the tungsten carbide rod;

FIG. 4 is a perspective view of the first embodiment in FIG. 3;

FIG. 5 is a schematic view of a second embodiment of the micro-drill of the invention shaped from the integrated stainless steel rod and the tungsten carbide rod;

FIG. 6 is a perspective view of the second embodiment in FIG. 5;

FIG. 7 is a schematic view of a third embodiment of the micro-drill of the invention shaped from the integrated stainless steel rod and the tungsten carbide rod;

FIG. 8 is a perspective view of the third embodiment in FIG. 7;

FIG. 9 is a schematic view showing a stainless steel rod and a tungsten carbide in a process of manufacturing a conventional micro-drill;

FIG. 10 is a perspective view showing the stainless steel rod and the tungsten carbide which have not been assembled together; and

FIG. 11 is a schematic view showing the assembled conventional microdrill.

### DETAILED DESCRIPTION OF THE PREFERRED EMBODIMENT

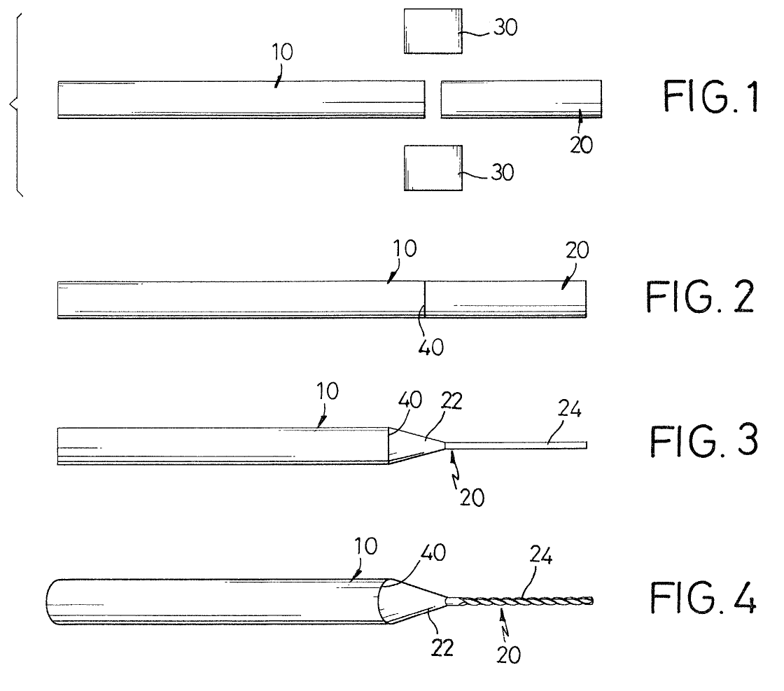

Referring to FIGS. 1 and 2, a micro-drill in accordance with the invention has a shank (10) made of a stainless steel. A tungsten carbide rod (20) is welded to an end of the shank (10). In welding, the shank (10) and the tungsten carbide rod (20) are clamped by fixtures and two heating devices (30) are oppositely located at the joint of the shank (10) and the tungsten carbide rod (20). The heating devices (30) provide heat to integrate the shank (10) and the tungsten carbide rod (20) with use of a proper solder. A welded segment (40) is formed between the shank (10) and the tungsten carbide rod (20).

With reference to FIGS. 3 and 4, in a first embodiment of the invention, a bit (24) is formed by cutting a distal end of the tungsten carbide rod (20). The bit (24) has a thread (not numbered) defined thereon. A tapering portion (22) is formed behind the bit (24), and a large end of the tapering portion (22) is located at the welded segment (40). Thus, the tungsten carbide rod (20) is securely integrated with the shank (10).

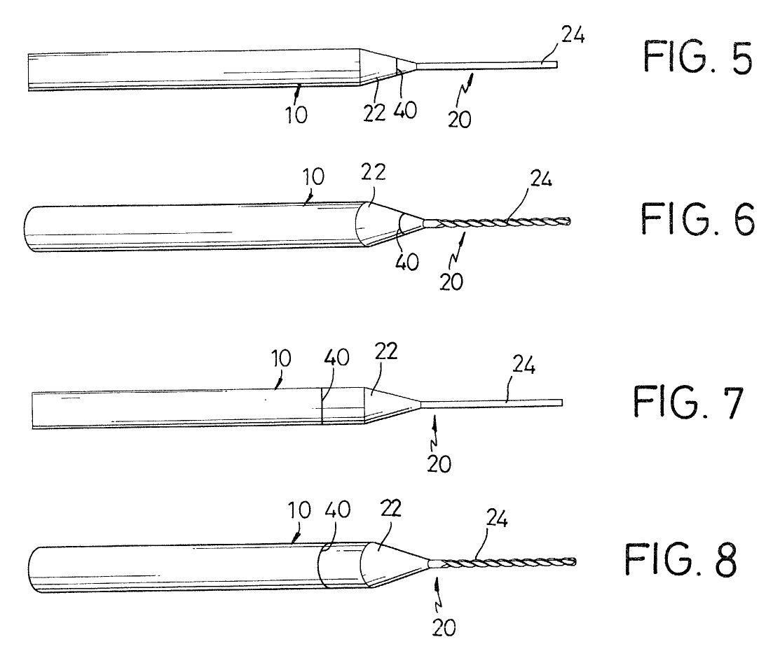

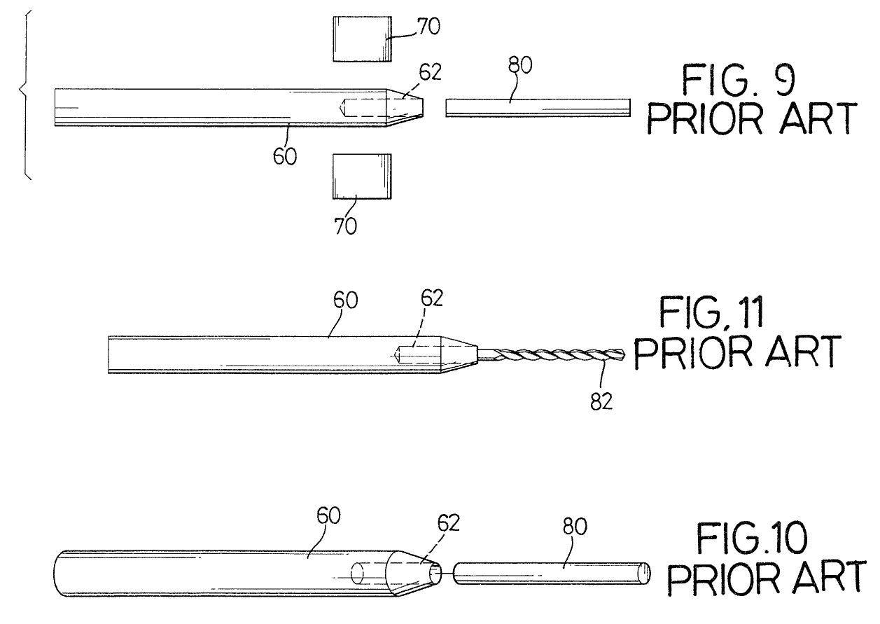

With reference to FIGS. 5 and 6, in a second embodiment of the invention, the welded segment (40) is located in the tapering portion (22). As an overall length of the micro-drill is usually 38.1 mm, a proper distance between the welded segment (40) and the large end of the tapering portion (22) is 5 mm or below. When the distance is above 5 mm, although the material of the tungsten carbide (20) can be saved, a section area of the welded segment (40) is too small and there is not enough engagement strength between the shank (10) and the tungsten carbide rod (20).

With reference to FIGS. 7 and 8, in a third embodiment of the invention, the welded segment (40) is located behind the tapering portion (22). As an overall length of the micro-drill is usually 38.1 mm, a proper distance between the welded segment (40) and the large end of the tapering portion (22) is 5 mm or below. When the distance is above 5 mm, the tungsten carbide rod (20) is too long and it will increase the cost of material.

Furthermore, according to the present invention, the shank (10) can be made of a low-grade tungsten carbide, and the bit (24) can be made from a high-grade tungsten carbide rod welded on the shank (10).

According to a testing for the micro-drill, the micro-drill can bear a tensile force of at least 369 kg, and the oscillation of the bit (24) is below 30 m. In a conventional micro-drill, the two values above are 260 kg and 300 m respectively. Therefore, the micro-drill has a reinforced strength and a high machining precision. Because the bit (24) is integrated with the shank (10) to eliminate the problem that a diameter of the bore to secure the bit is limited, the bit (24) can be manufactured with a diameter of a minimum of 0.1 mm.

From the above description, it is noted that the invention has the following advantages:

1. The micro-drill has a tensile resistance of above 369 kg, which is larger than an average value 260 kg in a conventional micro-drill.

2. Because the shank (10) and the tungsten carbide rod (20) are clamped by special fixtures in welding, an oscillation of the bit (24) is below 30 m and the micro-drill has a high machining precision.

3. Because the shank (10) does not have a bore to install the bit, the process is simple and the manufacturing cost is low.

4. The bit (24) can be made with a minimum diameter of 0.1 mm.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of pairs within the principles of the invention to the full extent indicated by the broad general meaning of the terms in which the appended claims are expressed.

What is claimed is:

1. A micro-drill comprising:
a shank (10);
a bit (24) integrated with the shank (10) by welding;
a tapering portion (22) formed behind the bit (24); and
a welded segment (40) located between the shank (10) and the bit (24).

2. The micro-drill as claimed in claim 1, wherein a distance between the welded segment (40) and a large end of the tapering portion (22) is 5 mm or below.

3. The micro-drill as claimed in claim 1, wherein the shank (10) is made of a stainless steel, and the bit (24) is made of a tungsten carbide.

4. The micro-drill as claimed in claim 1, wherein the shank (10) is made of a low-grade tungsten carbide, and the bit (24) is made of a high-grade tungsten carbide.
